(19) United States
(12) Patent Application Publication
(10) Pub. No.: US 2019/0176331 A1
(43) Pub. Date: Jun. 13, 2019

(54) WATCHING ROBOT

(71) Applicant: CASIO COMPUTER CO., LTD., Tokyo (JP)

(72) Inventors: Hiroyoshi OGAWA, Tokyo (JP); Katsunori ISHII, Tokyo (JP); Tamotsu HASHIKAMI, Tokyo (JP)

(73) Assignee: CASIO COMPUTER CO., LTD., Tokyo (JP)

(21) Appl. No.: 16/190,077

(22) Filed: Nov. 13, 2018

(30) Foreign Application Priority Data
Dec. 7, 2017 (JP) 2017-235232

(51) Int. Cl. B25J 9/16; G06F 3/16; B25J 11/00

(52) U.S. Cl. CPC B25J 9/1674; B25J 9/1697; B25J 11/0005; B25J 9/1679; G06F 3/167

(57) ABSTRACT

A watching robot in the present invention includes an action detection unit that detects an action of a user, an action determination unit that determines an action of the watching robot based on the action of the user detected by the action detection unit, an action control unit that controls the watching robot to perform the action determined by the action determination unit, and an output unit that externally outputs information about the action of the watching robot determined by the action determination unit.

### CROSS-REFERENCE TO RELATED APPLICATIONS

This application claims priority from Japanese Patent Application No. 2017-235232 filed on Dec. 7, 2017, the contents of which are incorporated herein by reference in their entirety.

### FIELD OF THE INVENTION

The present invention relates to a watching robot.

### BACKGROUND OF THE INVENTION

There is, for example, a known living-watching system capable of securing the safety of a person to be watched and of reducing the load on a center system by installing sensors, cameras, and the like in a house without unnecessarily intruding the privacy of the person to be watched (See JP 2002-109666 A).

### SUMMARY OF THE INVENTION

A watching robot includes: a processor; and a storage unit configured to store a program to be executed by the processor, wherein the processor executes in accordance with the program stored in the storage unit: an action detection process of detecting an action of a user; an action determination process of determining an action of the watching robot based on the action of the user detected by the action detection process; an action control process of controlling the watching robot to perform the action determined by the action determination process; and an output process of externally outputting information about the action of the watching robot determined by the action determination process.

### BRIEF DESCRIPTION OF THE DRAWINGS

FIG. 1 is an explanatory diagram of an action watching system using a watching robot according to an embodiment of the present invention;

FIG. 2 is a block diagram showing a configuration of the watching robot according to the embodiment of the present invention;

FIG. 3 is an explanatory diagram of operation of the watching robot according to the embodiment of the present invention, and is an explanatory diagram of operation at the time of getting up;

FIG. 4 is an explanatory diagram of operation of the watching robot according to the embodiment of the present invention, and is an explanatory diagram of operation at the time of watching television;

FIG. 5 is an explanatory diagram of operation of the watching robot according to the embodiment of the present invention, and is an explanatory diagram of operation at the time of going out;

FIG. 6 is an explanatory diagram of operation of the watching robot according to the embodiment of the present invention, and is an explanatory diagram of operation at the time of returning home;

FIG. 7 is an explanatory diagram of operation of the watching robot according to the embodiment of the present invention, and is an explanatory diagram of operation at the time of taking a bath; and

FIG. 8 is an explanatory diagram of operation of the watching robot according to the embodiment of the present invention, and is an explanatory diagram of operation at the time of going to bed.

### DETAILED DESCRIPTION OF THE PREFERRED EMBODIMENTS

Hereinafter, a mode for carrying out the present invention (hereinafter referred to as an “embodiment”) is described in detail with reference to the accompanying drawings.

In the description of the embodiment, the same reference signs are assigned to the same elements.

[Action Watching System 100]

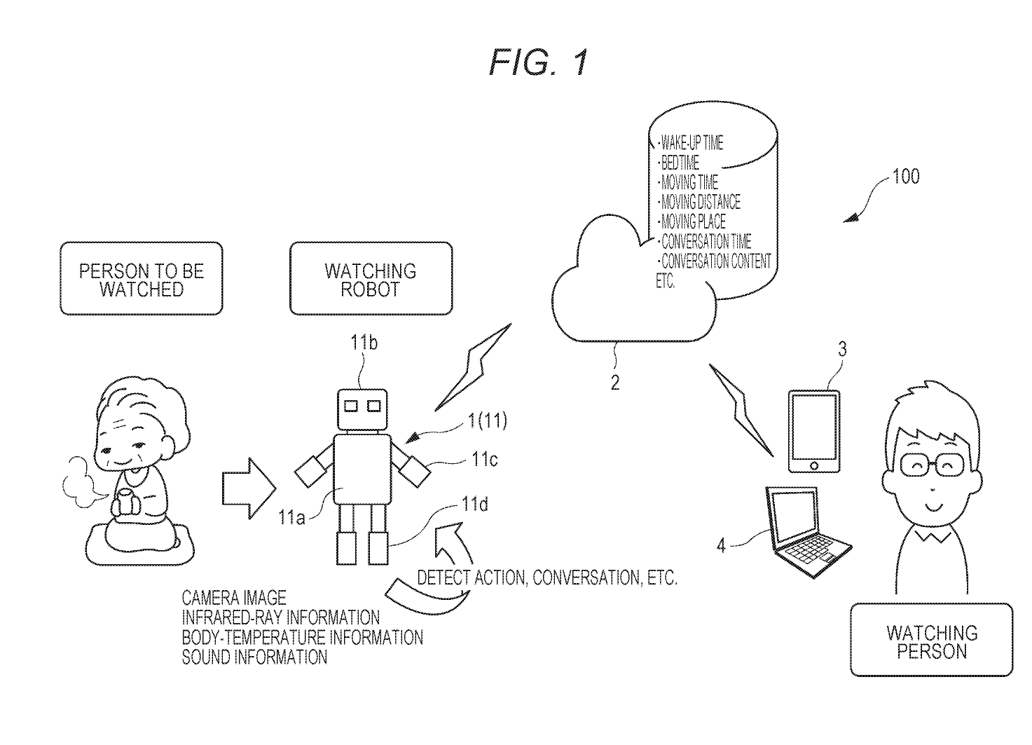

FIG. 1 is an explanatory diagram of an action watching system 100 using a watching robot 1 according to the embodiment of the present invention.

As shown in FIG. 1, the action watching system 100 according to the present embodiment includes a watching robot 1, a cloud 2, and a communication device (for example, a smartphone 3 or a PC 4). The watching robot 1 is installed in a house of a user to be watched (for example, an elderly person living alone) and watches actions of the user. The cloud 2 is installed on a network, such as the Internet, and action information about the user is uploaded to the cloud 2. The communication device is used by a third person who watches the user (for example, a relative of the user).

The watching robot 1 watches the actions of the user in the house and uploads action information about the user (for example, a wake-up time, a bedtime, a moving time, a moving distance, a conversation time, conversation content, and the like) to the cloud 2 to allow the third person to browse.

In addition, the watching robot 1 is capable of notifying the smartphone 3 or the PC 4 of the third person directly (by e-mail, an SNS message, or the like) of the action information about the user in case of emergency.

The watching robot 1 is assumed to be a biped walking type having two legs, but a driving mode of the watching robot 1 in the present embodiment is wheel traveling in which the watching robot 1 travels (hereinafter also referred to as “to walk”) based on the rotational driving of wheels (not shown) disposed on the soles of the feet.

However, the driving mode can be various driving modes such as a biped walking type robot that is driven by actually bending and stretching the legs, and a quadruped walking type robot with four legs.

[Configuration of Watching Robot 1]

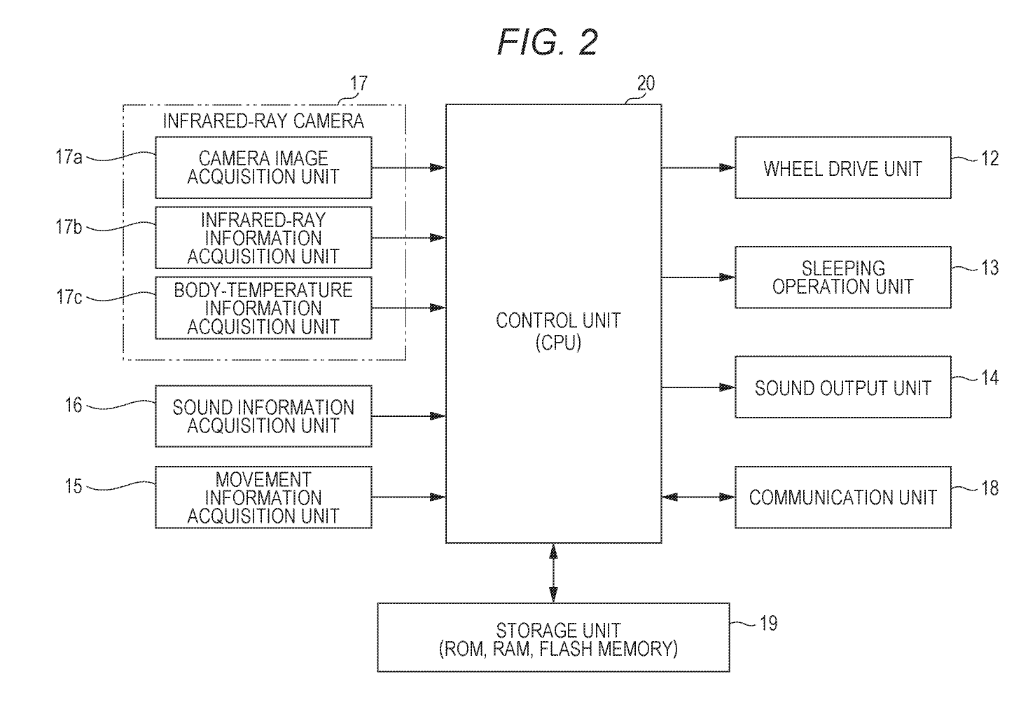

FIG. 2 is a block diagram showing a configuration of the watching robot 1 according to the embodiment of the present invention.

As shown in FIGS. 1 and 2, the watching robot 1 includes a housing 11, a wheel drive unit 12, a sleeping operation unit 13, a sound output unit 14, a movement information acquisition unit 15, a sound information acquisition unit 16, a camera image acquisition unit 17a, an infrared-ray information acquisition unit 17b, a body-temperature information acquisition unit 17c, a communication unit 18, a storage unit 19, and a control unit 20.

The housing 11 accommodates the components of the watching robot 1 and provides the appearance of the biped walking robot.

Specifically, the housing 11 includes a body part 11a, a head part 11b, left and right arm parts 11c, and left and right leg parts 11d to have the appearance of the biped walking robot.

The wheel drive unit 12 moves the watching robot 1 in an arbitrary direction based on rotational driving of a pair of wheels disposed on the soles of the feet of the left and right legs 11d.

For example, in order to move the watching robot 1 forward, the control unit 20 controls the wheel drive unit 12 to rotate the left and right wheels in the normal rotation direction.

Alternatively, in order to move the watching robot 1 backward, the control unit 20 controls the wheel drive unit 12 to rotate the left and right wheels in the reverse rotation direction.

In order to turn the watching robot 1 to the right, the control unit 20 controls the wheel drive unit 12 to rotate the left wheel in the normal rotation direction and to simultaneously rotate the right wheel in the reverse rotation direction. In order to turn the watching robot 1 to the left, the control unit 20 controls the wheel drive unit 12 to rotate the right wheel in the normal rotation direction and to simultaneously rotate the left wheel in the reverse rotation direction.

The sleeping operation unit 13 operates the watching robot 1 in a sleeping posture (a posture that makes the user recognize that the watching robot 1 is in the sleeping state).

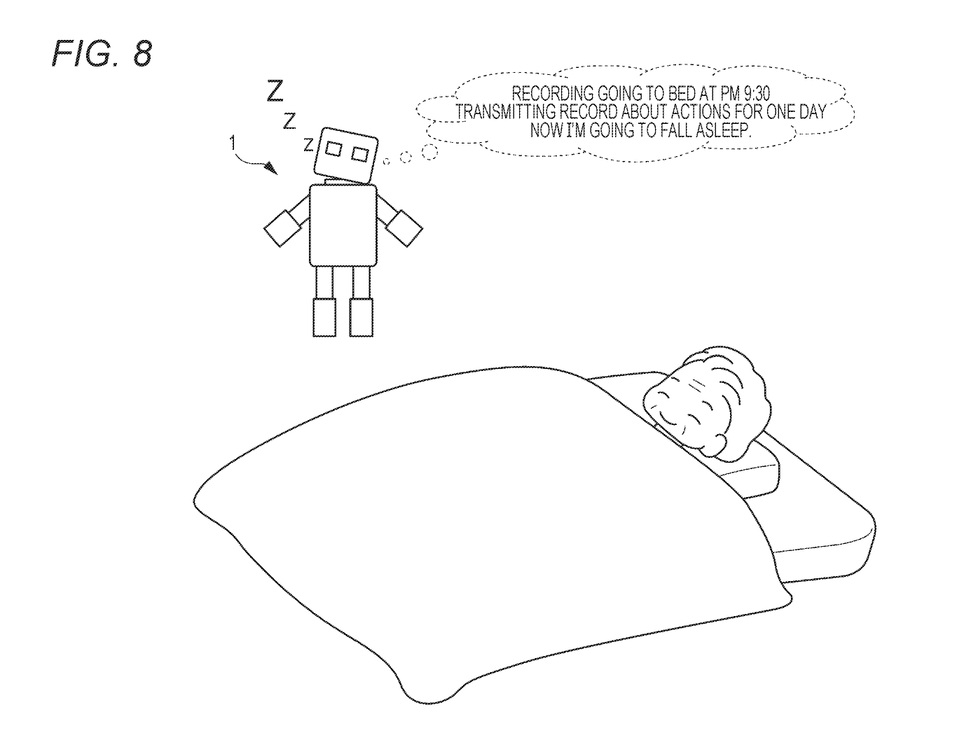

The sleeping operation unit 13 in the present embodiment tilts the head part 11b to one side to make the user recognize that the watching robot 1 is in the sleeping state (see FIG. 8).

The sound output unit 14 is for speaking to the user and talking with the user.

Specifically, the sound output unit 14 includes a sound conversion module that converts text data into sound data, an amplifier that amplifies sound data, and a speaker that outputs sound.

The movement information acquisition unit 15 detects a movement distance and a movement direction of the watching robot 1.

A sensor constituting the movement information acquisition unit 15 is, for example, a rotary encoder that detects the rotation speed and the rotation direction of the pair of wheels, or an optical movement sensor that optically detects the movement of an object (for example, a sensor used for movement detection of an optical mouse).

The sound information acquisition unit 16 is for talking with the user and recording the voice of the user, and includes a microphone.

The camera image acquisition unit 17a recognizes the position and the posture of the user.

The camera image acquisition unit 17a in the present embodiment includes an infrared-ray camera 17 and is disposed in the head part 11b of the watching robot 1.

Specifically, the camera image acquisition unit 17a is provided so that the lens portion is positioned at the eye position of the watching robot 1.

The infrared-ray information acquisition unit 17b detects the position of the user in a dark place.

The infrared-ray camera 17 is also used for the infrared-ray information acquisition unit 17b in the present embodiment.

The body-temperature information acquisition unit 17c detects the body temperature of the user.

The infrared-ray camera 17 is also used for the body-temperature information acquisition unit 17c in the present embodiment.

The communication unit 18 uploads action information about the user to the cloud 2 and directly notifies the smartphone 3 or the PC 4 of the third person.

The communication unit 18 in the present embodiment includes a wireless communication module conforming to the wireless LAN standard, such as Wi-Fi (registered trademark), and is connected to the Internet via a wireless LAN access point or the like installed in the house.

The storage unit 19 stores a control program for the watching robot 1, the detected action information about the user, the floor plan of the house, and the like.

The storage unit 19 includes a ROM that is a nonvolatile memory, a RAM that is a volatile memory, and a flash memory that is a rewritable nonvolatile memory.

For example, the ROM stores the control program for the watching robot 1, and the RAM is used as a work area of the control program and stores the detected action information about the user.

The flash memory stores setting data (user information, the floor plan of the house, and the like) and the detected action information about the user.

The control unit 20 controls operation of the watching robot 1.

The watching robot 1 in the present embodiment includes an action detection unit, an action control unit, a recording control unit, and an output unit as functional components implemented by the cooperation of hardware including the control unit 20 (CPU) and software including the control program and the setting data.

Hereinafter, the functional configuration is described in detail.

[Functional Components of Watching Robot 1]

The action detection unit detects an action of the user.

The action detection unit in the present embodiment is implemented by the cooperation of hardware including the movement information acquisition unit 15, the sound information acquisition unit 16, the infrared-ray camera 17 (the camera image acquisition unit 17a, the infrared-ray information acquisition unit 17b, and the body-temperature information acquisition unit 17c), the storage unit 19, and the control unit 20, and software including the control program and the setting data.

Then, the action detection unit in the present embodiment detects, for example, that the user is awake or asleep, that the user is moving, that the user has spoken to the watching robot 1, and the like.

The action control unit controls the action of the watching robot 1 in response to the action of the user detected by the action detection unit.

The action control unit in the present embodiment is implemented by the cooperation of hardware including the wheel drive unit 12, the sleeping operation unit 13, the sound output unit 14, the storage unit 19, and the control unit 20, and software including the control program and the setting data.

When the action detection unit detects that the user is awake, the action control unit in the present embodiment controls the watching robot 1 to be in a state of being awake (performs sleeping-posture canceling operation).

Alternatively, when the action detection unit detects that the user is asleep, the action control unit controls the watching robot 1 to be in a state of being asleep (performs sleeping-posture operation).

In addition, when the action detection unit detects that the user is moving, the action control unit controls the watching robot 1 to move (walk) and follow the user.

As described above, the moving state of the watching robot 1 (for example, where it has moved in the house) is continuously acquired by acquiring the movement distance and the movement direction of the watching robot 1 by the movement information acquisition unit 15, and by comparing them with the floor plan stored in the storage unit 19.

When the action detection unit detects that the user has spoken to the watching robot 1, the action control unit controls the watching robot 1 to talk with the user.

The recording control unit records the action information about the user detected by the action detection unit in a recording unit of the storage unit 19.

The action information about the user is recorded in the recording unit (an action information recording area) of the storage unit 19, but the recording unit is simply described as the storage unit 19 in the following description.

The recording control unit in the present embodiment is implemented by the cooperation of hardware including the storage unit 19 and the control unit 20, and software including the control program and the setting data.

Then, the recording control unit in the present embodiment records, in the storage unit 19, action information about the watching robot 1 executed under the control of the action control unit as the action information about the user.

For example, the recording control unit records, in the storage unit 19, a time from the time when the watching robot 1 has been controlled to be in the state of being awake until the time when the watching robot 1 has been controlled to be in the state of being asleep as the action information about the user (user's activity time).

The recording control unit further records, in the storage unit 19, a time during which the watching robot 1 is being controlled by the action control unit to move (walk) as the action information about the user (user's walking time in the house).

As described above, the movement state of the watching robot 1 (for example, where the watching robot 1 has moved in the house) is continuously acquired, and the recording control unit records, in the storage unit 19, the action information about the watching robot 1 (for example, moving to the bedroom, moving to the living room, and the like) based on the moving state or the like executed by the action control unit as the action information about the user (for example, moving to the bedroom, moving to the living room, and the like).

The recording control unit further records, in the storage unit 19, a time during which the watching robot 1 is being controlled by the action control unit to talk with the user as the action information about the user (user's conversation time).

The output unit externally outputs the action information about the watching robot 1 recorded in the storage unit 19.

The output unit in the present embodiment is implemented by the cooperation of hardware including the communication unit 18, the storage unit 19, and the control unit 20, and software including the control program and the setting data.

Then, the output unit in this embodiment outputs the action information about the user recorded in the storage unit 19 as described above to the outside (the cloud 2), or to a third person different from the user (the smart phone 3 or the PC 4).

For example, the output unit in the present embodiment uploads the action information about the user recorded in the storage unit 19 to the cloud 2 at a fixed time once a day.

The time for uploading is not particularly limited, and is set to, for example, 10 o'clock in the evening, which is the time when the user is likely to go to bed.

However, the output unit may upload to the cloud 2 at the timing of recording the action information about the user in the storage unit 19 incorporated in the watching robot 1.

In this case, the storage unit 19 does not need to hold the action information about the user for a long time and may be, for example, a transmission buffer that temporarily holds data which is the data to be transmitted when the output unit accesses the cloud 2 at the timing of recording.

Accordingly, it is possible to reduce the area size of the storage unit 19 used for recording the action information about the user, and to reduce the capacity required for the storage unit 19.

However, the action information about the user is not limited to being uploaded to the cloud 2. When a third person who watches the user desires to acquire the action information about the user by directly accessing the watching robot 1 with a communication device (for example, the smartphone 3 or the PC 4), the action information about the user for several days may be held by increasing the area size of the storage unit 19 used for recording the action information about the user.

[Operation of Watching Robot 1]

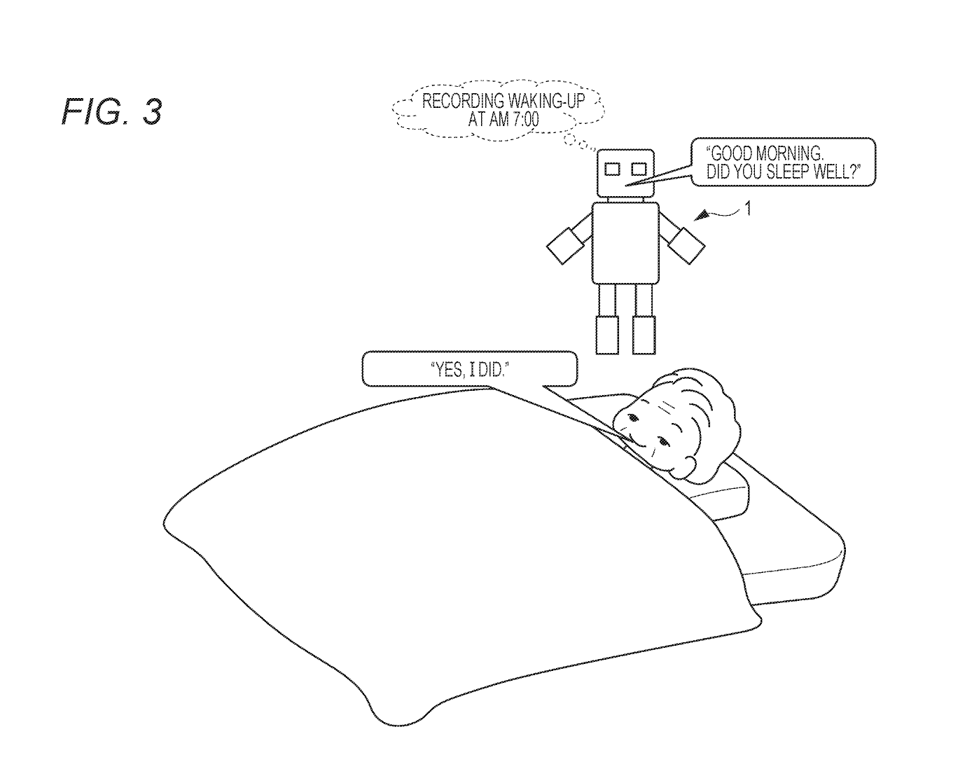

Next, with reference to FIGS. 3 to 8, specific processing content of each functional component is described in accordance with specific operation of the watching robot 1 on a day.

FIG. 3 is an explanatory diagram of operation of the watching robot 1 according to the embodiment of the present invention, and is an explanatory diagram of operation at the time of getting up.

When the user is asleep, the watching robot 1 watches the user in the room (bedroom) where the user is asleep in a state in which the watching robot 1 seems to be also asleep (see FIG. 8).

Then, when the infrared-ray camera 17 detects the user's movement or the sound information acquisition unit 16 detects the user's voice (for example, “Good morning”), the action detection unit determines that the user has woken up.

For example, as shown in FIG. 3, when the action detection unit detects that the user has woken up (for example, when detecting that the user's eyes are opened, that the body temperature has risen, or the like), the action control unit controls the watching robot 1 to be in a state of being awake (performs sleeping-posture canceling operation) and to speak to the user such as “Good morning. Did you sleep well?”

Then, the recording control unit records, in the storage unit 19, the wake-up time (for example, waking-up at AM 7:00), which means that the watching robot 1 has been controlled by the action control unit to be in the state of being awake, as the action information about the user detected by the action detection unit.

Note that, if the user does not wake up although the normal wake-up time passes, the watching robot 1 may notify the smartphone 3 or the PC 4 of the third person of such a message.

The action detection unit detects that the user is moving during the user is awake and detects that the user has spoken to the watching robot 1.

When the action detection unit detects that the user is moving during the user is awake, the action control unit controls the watching robot 1 to walk and follow the user. When the action detection unit detects that the user has spoken to the watching robot 1, the action control unit controls the watching robot 1 to talk with the user.

Since the watching robot 1 can recognize where itself is in the house or the like as described above, the watching robot 1 in the present embodiment speaks to the user depending on the situation as to be described later.

Then, the recording control unit records, in the storage unit 19, the action information about the watching robot 1 executed by the action control unit as the action information about the user.

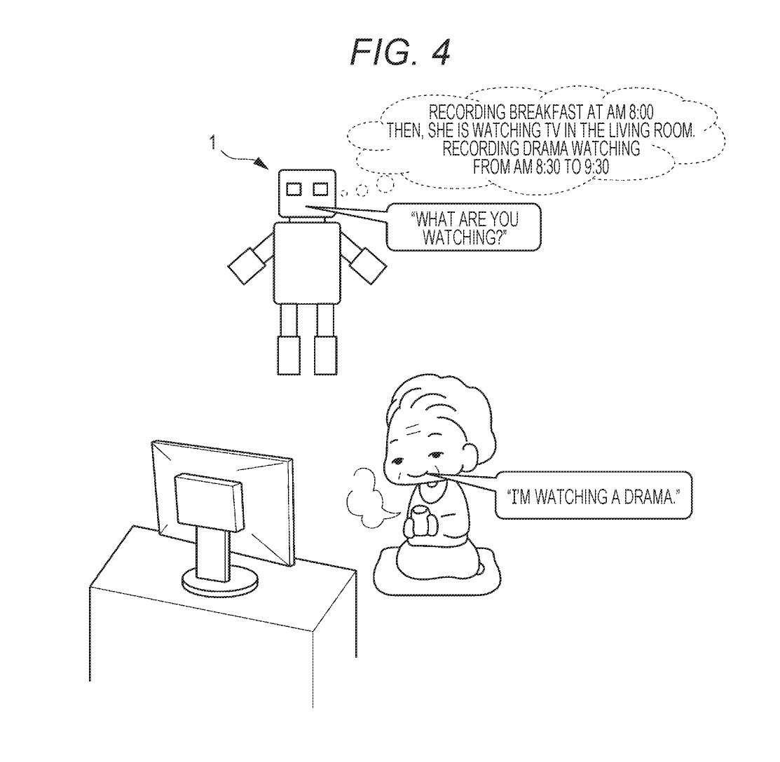

A specific example of operation of the watching robot 1 during the user is awake is described with reference to FIG. 4.

FIG. 4 is an explanatory diagram of operation of the watching robot 1 according to the embodiment of the present invention, and is an explanatory diagram of operation at the time of watching television.

FIG. 4 specifically shows that the user has moved to the living room and is watching television after the user has had a meal (breakfast), and, hereafter, the description is to be made from the situation before the user moves to the living room.

As shown in FIG. 3, when the user moves to a dining room where the user always eats after waking up, the watching robot 1 also moves (walks) and follows the user to the dining room.

The recording control unit records, in the storage unit 19, a time required for the watching robot 1 to move (walk) and follow the user from the bedroom to the dining room executed by the action control unit (walking time of the watching robot 1) as the action information about the user (walking time of the user).

At this time, the recording control unit may record, in the storage unit 19, the movement from the bedroom to the dining room.

Then, since the user moves to the dining room for the first time after waking up, the action control unit controls the watching robot 1 to talk with the user about breakfast (for example, the watching robot 1 says “Are you going to have breakfast?” and the user replies “Yes.”).

Although the explanation can be omitted in the following description, the recording control unit records, in storage unit 19, a time during which the watching robot 1 is being controlled by the action control unit to talk with the user as the action information about the user (conversation time).

In addition, the recording control unit may record not only the time but also the content of the conversation in the storage unit 19.

Here, it is assumed that the action detection unit detects, for example, the action of the user for leaving the dining room to go to the living room.

Then, the action control unit controls the watching robot 1 to speak to the user such as “Was the breakfast good?”. When receiving the reply from the user such as “It was good.” which is the response when the user has had a meal, the action control unit further controls the watching robot 1 to reply such as “My breakfast was also good.” as if the watching robot 1 has had a meal together.

Then, the recording control unit records, in the storage unit 19, the breakfast time (for example, breakfast at AM 8:00), which means the action information that the watching robot 1 has been controlled by the action control unit to perform as if having had a meal together such as “My breakfast was also good”, as the action information about the user detected by the action detection unit.

The recording control unit may record the breakfast time (for example, breakfast at AM 8:00), which means that the watching robot 1 has been controlled by the action control unit to move to the dining room after the watching robot 1 is controlled by the action control unit to be in the state of being awake, as the action information about the user detected by the action detection unit.

Then, since the action control unit controls the watching robot 1 to walk and follow the user according to the user's movement detected by the action detection unit, when the user moves to the living room, the watching robot 1 also moves to the living room as shown in FIG. 4.

At this time, the recording control unit records, in the storage unit 19, a time required for the watching robot 1 to move (walk) and follow the user from the dining room to the living room executed by the action control unit as the action information about the user (walking time of the user).

Here, when the action detection unit detects that the movement of the user for turning on the television, the action control unit controls the watching robot 1 to talk with the user about watching of television (for example, the watching robot 1 says “What are you watching?”, and the user replies “I'm watching a drama”). Then, the action control unit further controls the watching robot 1 to speak such as “I'm going to watch the drama too.” as if the watching robot 1 watches the drama together with the user.

Then, as shown in FIG. 4, the recording control unit records, in the storage unit 19, the TV watching time (for example, drama watching from AM 8:30 to 9:30), which means the action information that the watching robot 1 has been controlled by the action control unit to watch a drama in the living room, as the action information about the user at the timing when the user turns off the television or leaves from the living room.

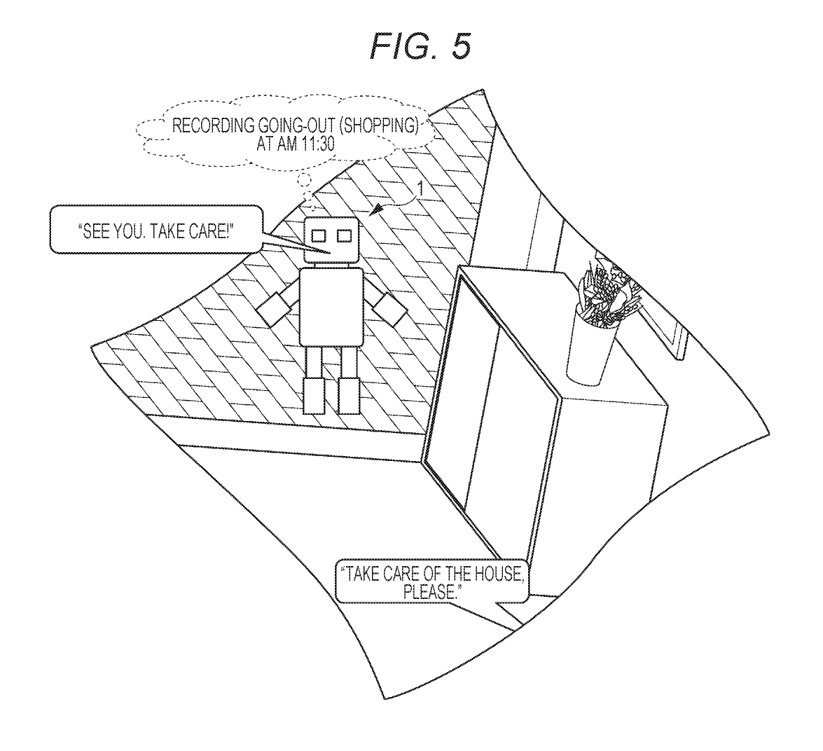

Next, another specific example of operation of the watching robot 1 during the user is awake is described with reference to FIG. 5.

FIG. 5 is an explanatory diagram of operation of the watching robot 1 according to the embodiment of the present invention, and is an explanatory diagram of operation at the time of going out.

For example, when the user moves to the entrance to go out, the action control unit controls the watching robot 1 to move (walk) and follow the user according to the user's movement detected by the action detection unit, and the watching robot 1 also moves to the entrance as shown in FIG. 5.

The recording control unit records, in the storage unit 19, a time required for the watching robot 1 to move (walk) and follow the user to the entrance executed by the action control unit (walking time of the watching robot 1) as the action information about the user (walking time of the user).

At this time, for example, when the watching robot 1 has moved (walked) from the living room to the entrance, the recording control unit may record the movement from the living room to the entrance in the storage unit 19.

Then, the recording control unit records, in the storage unit 19, the going-out time (for example, going out at AM 11:30), which means that the watching robot 1 has been controlled by the action control unit to move (walk) and follow the user to the entrance, as the action information about the user.

At this time, the action control unit may control the watching robot 1 to speak to the user such as “Take care. See you!” as shown in FIG. 5.

In addition, the action control unit may control the watching robot 1 to ask the user about what time he/she will return home to acquire the time when the user is scheduled to return home. Then, if the user does not return home after the scheduled time passes significantly, the watching robot 1 may notify the smartphone 3 or the PC 4 of the third person that the user has not returned home after the scheduled time.

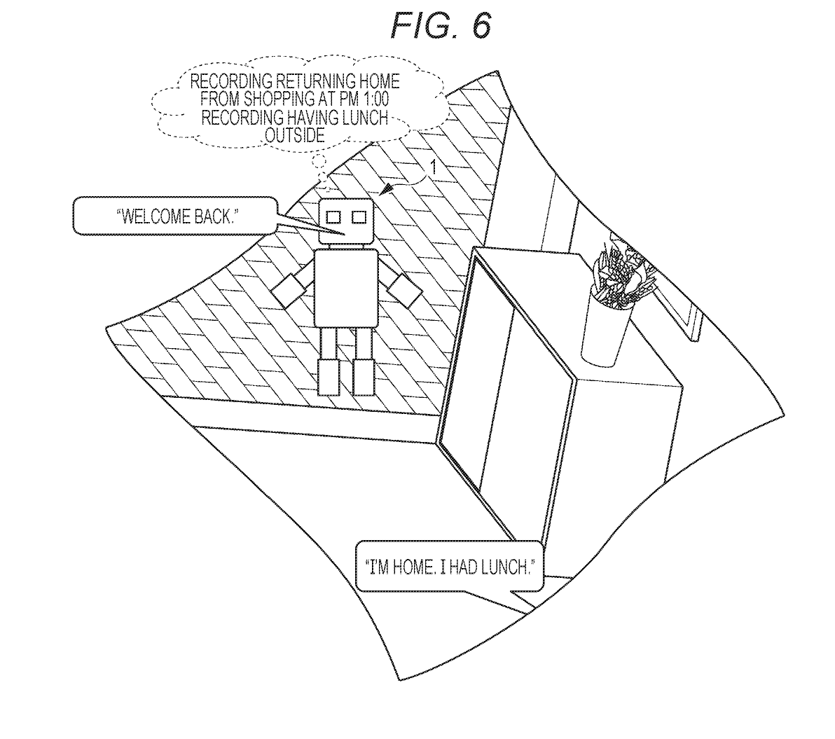

Next, another specific example of operation of the watching robot 1 during the user is awake is described with reference to FIG. 6.

FIG. 6 is an explanatory diagram of operation of the watching robot 1 according to the embodiment of the present invention, and is an explanatory diagram of operation at the time of returning home.

As shown in FIG. 6, when the user goes out, the watching robot 1 stands by at the entrance until the user returns home.

When the action detection unit detects that the user returns home, the action control unit controls the watching robot 1 to talk with the user (for example, the watching robot 1 says “Welcome back.” and the user replies “I'm home. I had lunch.”).

In addition, when the action detection unit detects “I had lunch.” or the like, the action control unit controls the watching robot 1 to speak to the user such as “I went out to have lunch too.” as if the watching robot 1 ate out.

Then, when the action detection unit detects that the user moves from the entrance to the living room or the like, and the watching robot 1 is controlled by the action control unit to move (walk) and follow the user, the recording control unit records, in the storage unit 19, the time when the user has returned home (for example, returning home at PM 1:00, having lunch outside), which means the action information that the watching robot 1 has been controlled by the action control unit to perform as if the watching robot 1 went out to have lunch, as the action information about the user as shown in FIG. 5.

The watching robot 1 is not necessarily controlled to perform as if it ate out by imitating the user.

For example, at the timing when the action detection unit detects that the user moves from the entrance to the living room or the like, and the action control unit controls the watching robot 1 to move (walk) and follow the user, the recording control unit may record, in the storage unit 19, the time when the user has returned home (for example, returning home at PM 1:00), which means the action information that the watching robot 1 has been controlled by the action control unit to move from the entrance to somewhere in the house, as the action information about the user.

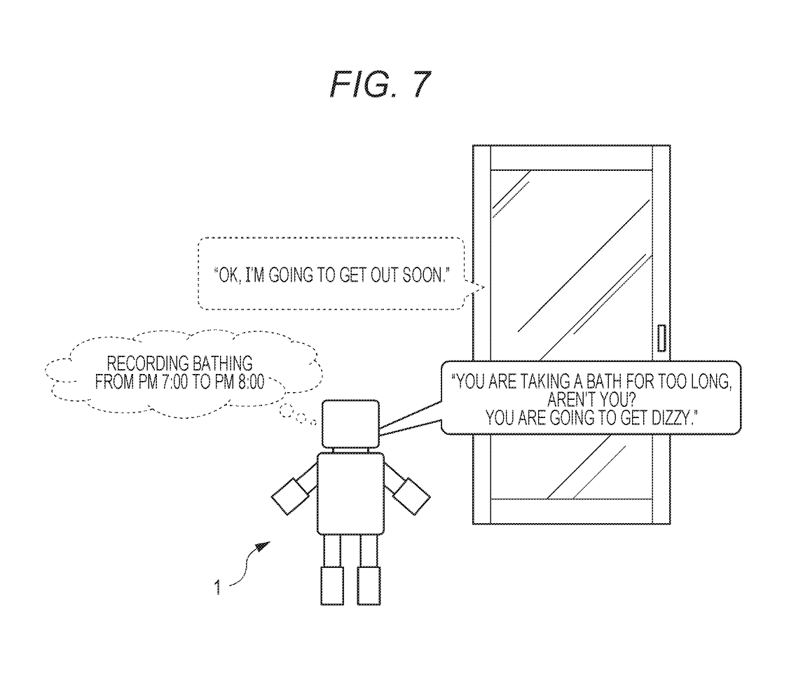

Next, another specific example of operation of the watching robot 1 during the user is awake is described with reference to FIG. 7.

FIG. 7 is an explanatory diagram of operation of the watching robot 1 according to the embodiment of the present invention, and is an explanatory diagram of operation at the time of taking a bath.

When the user moves to the bathroom, the action control unit controls the watching robot 1 to move (walk) and follow the user according to the user's movement detected by the action detection unit, and the watching robot 1 also moves to the bathroom as shown in FIG. 7.

The recording control unit records, in the storage unit 19, a time required for the watching robot 1 to move (walk) to the bathroom executed by the action control unit (walking time of the watching robot 1) as the action information about the user (walking time of the user).

At this time, for example, when the watching robot 1 has moved (walked) from the living room to the bathroom, the recording control unit may record the movement from the living room to the bathroom in the storage unit 19.

Since the user moves from the bathroom to another place after taking a bath, at the timing when the action detection unit detects that the user leaves the bathroom, and the action control unit controls the watching robot 1 to leave the bathroom, the recording control unit records, in the storage unit 19, the bathing time (for example, bathing from PM 7:00 to PM 8:00), which means the action information that the watching robot 1 has been controlled by the action control unit to move to the bathroom, as the action information about the user as shown in FIG. 7.

For example, by setting the normal bathing time in the watching robot 1, when the bathing time of the user passes the set bathing time, the action control unit may control the watching robot 1 to speak to the user (for example, “You are taking a bath for too long, aren't you? You are going to get dizzy.”) as shown in FIG. 7.

In this case, when the action detection unit cannot detect a reply from the user (for example, “OK, I'm going to get out soon.”), an emergency message may be transmitted from the watching robot 1 to the smartphone 3 or the PC 4 of the third person.

In addition, such an emergency message may be transmitted when the action detection unit detects that the user is in the toilet for too long, or that the user suddenly falls down and does not move.

Next, another specific example of operation of the watching robot 1 during the user is awake is described with reference to FIG. 8.

FIG. 8 is an explanatory diagram of operation of the watching robot 1 according to the embodiment of the present invention, and is an explanatory diagram of operation at the time of going to bed.

When the user moves to the bedroom to go to bed, the action control unit controls the watching robot 1 to move (walk) and follow the user according to the user's movement detected by the action detection unit, and the watching robot 1 also moves to the bedroom as shown in FIG. 8.

The recording control unit records, in the storage unit 19, a time required for the watching robot 1 to move (walk) to the bedroom executed by the action control unit (walking time of the watching robot 1) as the action information about the user (walking time of the user).

At this time, for example, when the watching robot 1 has moved (walked) from the living room to the bedroom, the recording control unit may record the movement from the living room to the bedroom in the storage unit 19.

Then, when the action detection unit detects that the user has fallen asleep (for example, the eyes are closed), the action control unit controls the watching robot 1 to be in the sleeping posture.

Then, the recording control unit records, in the storage unit 19, the bedtime (for example, going to bed at PM 9:30), which means the action information that the watching robot 1 has been controlled by the action control unit to sleep, as the action information about the user.

The output unit uploads the action information for one day to the cloud 2 at a predetermined output time (for example, at PM 10:00).

However, the action information about the user is not limited to being uploaded just as it is recorded in the storage unit 19 as described above.

For example, the moving time, the moving distance, the conversation time, and the like may be totalized in one day and uploaded.

As described above, although various sensors are used to watch the user, the sensors are built in the watching robot 1, and it is difficult for the user to be aware of the various sensors and to have the feeling of being monitored.

Furthermore, since the watching robot 1 in the present embodiment is capable of talking with the user, it is possible for the user to have the feeling being with an acquaintance (for example, a son or grandchild in the case of an elderly user), and to prevent the user from having the feeling of being monitored.

Particularly, by controlling the watching robot 1 to reply as if the watching robot 1 has had the same action as the user, for example, when the user finishes breakfast, the watching robot 1 answers as if having had breakfast too, or when the user returns home from going out, the watching robot answers as if having gone out too, the user feels human life and easily gets attached to the watching robot 1, and it is possible to prevent the user from having the feeling of being monitored.

The watching robot 1 in the present invention has been described above based on a specific embodiment, but the present invention is not limited to the above specific embodiment

For example, it has been described that the infrared-ray camera 17 alone is provided as a camera in the above embodiment, but a third person who desires to watch the user sometimes desires to watch the facial expressions and daily life of the user in photographs or videos.

Thus, an ordinary camera, a video camera, and the like in addition to the infrared-ray camera 17 may be provided in the watching robot 1.

In addition, it has been described that the action information about the watching robot 1 executed under the control of the action control unit is recorded or externally transmitted as the action information about the user to be watched in the above embodiment. However, the action of the user to be watched which has been detected by the action detection unit may be directly recorded or externally transmitted.

Furthermore, it has been described that the action information about the user to be watched is transmitted to the communication device of a third person who watches the user (for example, a relative of the user) in the above embodiment. However, a robot similar to the watching robot 1 may be installed in the third person's house, and the robot in the third person's house may receive the action information about the watching robot 1 to be sequentially transmitted from the watching robot 1, and perform the same action as the action of the watching robot 1 based on the received action information.

In this manner, since the robot in the house of the third person who watches the user performs the same action as the user to be watched, it is possible for the third person who watches the user to intuitively understand what the user to be watched is doing now by watching the action of the robot in the third person's house.

As described above, the present invention is not limited to specific embodiments, and various modifications and improvements are also included in the technical scope of the present invention, which is obvious to those skilled in the art from the description of the claims.

1. A watching robot comprising:
a processor; and
a storage unit configured to store a program to be executed by the processor, wherein
the processor executes in accordance with the program stored in the storage unit:
an action detection process of detecting an action of a user;
an action determination process of determining an action of the watching robot based on the action of the user detected by the action detection process;
an action control process of controlling the watching robot to perform the action determined by the action determination process; and
an output process of externally outputting information about the action of the watching robot determined by the action determination process.

2. The watching robot according to claim 1, wherein
the action detection process detects that the user is awake or asleep, and
the action determination process determines the watching robot to be in a state of being awake when the action detection process has detected that the user is awake, or the watching robot to be in a state of being asleep when the action detection process has detected that the user is asleep.

3. The watching robot according to claim 1, wherein
the action detection process detects that the user is moving, and
the action determination process determines the watching robot to walk when the action detection process has detected that the user is moving.

4. The watching robot according to claim 1, wherein
the action detection process detects that the user has spoken to the watching robot, and
the action determination process determines the watching robot to talk with the user when the action detection process has detected that the user has spoken to the watching robot.

5. The watching robot according to claim 1 further comprising:
a recording unit, wherein
the processor further executes a recording control process of recording, in the recording unit, information about the action of the user detected by the action detection process.

6. The watching robot according to claim 5, wherein the recording control process records, in the recording unit, information about the action of the watching robot determined by the action determination process.

7. The watching robot according to claim 6, wherein
the action detection process detects that the user is awake or asleep,
the action determination process determines the watching robot to be in a state of being awake when the action detection process has detected that the user is awake, and the watching robot to be in a state of being asleep when the action detection process has detected that the user is asleep, and
the recording control process records, in the recording unit, a time from a time when the action determination process has determined the watching robot to be in the state of being awake to a time when the action determination process has determined the watching robot to be in the state of being asleep.

8. The watching robot according to claim 6, wherein
the action detection process detects that the user is moving,
the action determination process determines the watching robot to walk when the action detection process has detected that the user is moving, and
the recording control process records, in the recording unit, a time during which the action determination process keeps determining the watching robot to walk.

9. The watching robot according to claim 6, wherein
the action detection process detects that the user has spoken to the watching robot,
the action determination process determines the watching robot to talk with the user when the action detection process has detected that the user has spoken to the watching robot, and
the recording control process records, in the recording unit, a time during which the action determination process keeps determining the watching robot to talk with the user.

10. The watching robot according to claim 1 further comprising:
a transmission unit, wherein
the output process transmits, from the transmission unit, the information about the action of the watching robot executed under the control of the action control process to a third person different from the user.

11. The watching robot according to claim 1 further comprising:
a transmission unit, wherein
the output process transmits, from the transmission unit, the information about the action of the watching robot executed under the control of the action control process to another robot.

12. A watching method by a watching robot, the method comprising:
an action detection step of detecting an action of a user;
an action determination step of determining an action of the watching robot based on the action of the user detected by the action detection step;
an action control step of controlling the watching robot to perform the action determined by the action determination step; and
an output step of externally outputting information about the action of the watching robot determined by the action determination step.

13. The watching method according to claim 12, wherein
the action detection step detects that the user is awake or asleep, and
the action determination step determines the watching robot to be in a state of being awake when the action detection step has detected that the user is awake, or the watching robot to be in a state of being asleep when the action detection step has detected that the user is asleep.

14. The watching method according to claim 12, wherein
the action detection step detects that the user is moving, and
the action determination step determines the watching robot to walk when the action detection step has detected that the user is moving.

15. The watching method according to claim 12, wherein
the action detection step detects that the user has spoken to the watching robot, and
the action determination step determines the watching robot to talk with the user when the action detection step has detected that the user has spoken to the watching robot.

16. A non-transitory computer-readable recording medium storing a program for causing a computer of a watching robot to function as:
an action detection unit configured to detect an action of a user;
an action determination unit configured to determine an action of the watching robot based on the action of the user detected by the action detection unit;
an action control unit configured to control the watching robot to perform the action determined by the action determination unit; and
an output unit configured to externally output information about the action of the watching robot determined by the action determination unit.

17. The non-transitory computer-readable recording medium according to claim 16, wherein
the action detection unit detects that the user is awake or asleep, and
the action determination unit determines the watching robot to be in a state of being awake when the action detection unit has detected that the user is awake, or the watching robot to be in a state of being asleep when the action detection unit has detected that the user is asleep.

18. The non-transitory computer-readable recording medium according to claim 16, wherein
the action detection unit detects that the user is moving, and
the action determination unit determines the watching robot to walk when the action detection unit has detected that the user is moving.

19. The non-transitory computer-readable recording medium according to claim 16, wherein
the action detection unit detects that the user has spoken to the watching robot, and
the action determination unit determines the watching robot to talk with the user when the action detection unit has detected that the user has spoken to the watching robot.
